(19) United States
(12) Patent Application Publication
(10) Pub. No.: US 2026/0105655 A1
(43) Pub. Date: Apr. 16, 2026

(54) LOW-LEVEL PERCEPTION (LLP) MODEL DISTILLATION THROUGH PERSPECTIVE VIEW CUTTING

(71) Applicant: QUALCOMM Incorporated, San Diego, CA (US)

(72) Inventors: Andreas SJADIN HALLSTRAND, Linköping (SE); Dennis LUNDSTROEM, Linköping (SE); Simon KEISALA, Linköping (SE)

(21) Appl. No.: 18/913,525

(22) Filed: Oct. 11, 2024

(51) Int. Cl. G06T 11/60; G06T 7/11

(52) U.S. Cl. CPC G06T 11/60; G06T 7/11; G06T 2207/20081; G06T 2207/20084; G06T 2207/30252; G06T 2210/61

(57) ABSTRACT

Systems and techniques are described for image processing. For example, a computing device can receive first images of an environment from multiple image sensors. The computing device can determine portions from the plurality of first images to generate second images (where a number of the second images is greater than a number of the first images). Each of the second images includes a respective portion of the portions. The computing device can process, by a perspective view encoder, the second images to generate perspective view features. The computing device can transform, by a view transformer, the perspective view features to bird's eye view (BEV) features and can process, by a BEV encoder, the BEV features to generate encoded BEV features. The computing device can detect, based on the BEV features, one or more objects within the environment.

### FIELD

The present disclosure generally relates to image processing. For example, aspects of the present disclosure relate to low-level perception (LLP) model distillation through perspective view cutting.

### BACKGROUND

Two-dimensional (2D) visual perception has seen a rapid development in recent years. Multi-camera low-level perception (LLP) models are used in computer vision to integrate data from multiple cameras located in different locations. LLP models can be used to transform low-level information (e.g., from 2D images captured from multiple cameras) to higher-level information, such as extracted features for object detection. Autonomous devices (e.g., such as autonomous driving vehicles and robotic devices) need to perceive their surroundings, which is a complex task in visual perception, for decision making purposes. These LLP models can be employed by autonomous devices to perform object detection within a bird's eye view (BEV) of their environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for image processing. In some aspects, an apparatus for image processing is provided. The apparatus includes at least one memory and at least one processor coupled to the at least one memory and configured to: receive, from a plurality of image sensors, a plurality of first images of an environment; determine a plurality of portions from the plurality of first images to generate a plurality of second images, wherein each second image of the plurality of second images includes a respective portion of the plurality of portions, and wherein a number of the plurality of second images is greater than a number of the plurality of first images; process the plurality of second images to generate a plurality of perspective view features; transform the plurality of perspective view features to bird's eye view (BEV) features; process the BEV features to generate encoded BEV features; and detect, based on the BEV features, one or more objects within the environment.

In some aspects, a method for image processing is provided. The method includes: receiving, from a plurality of image sensors, a plurality of first images of an environment; determining a plurality of portions from the plurality of first images to generate a plurality of second images, wherein each second image of the plurality of second images includes a respective portion of the plurality of portions, and wherein a number of the plurality of second images is greater than a number of the plurality of first images; processing, by a perspective view encoder, the plurality of second images to generate a plurality of perspective view features; transforming, by a view transformer, the plurality of perspective view features to bird's eye view (BEV) features; processing, by a BEV encoder, the BEV features to generate encoded BEV features; and detecting, based on the BEV features, one or more objects within the environment.

In some aspects, a non-transitory computer-readable medium is provided having stored thereon instructions that, when executed by at least one processor, cause the at least one processor to: receive, from a plurality of image sensors, a plurality of first images of an environment; determine a plurality of portions from the plurality of first images to generate a plurality of second images, wherein each second image of the plurality of second images includes a respective portion of the plurality of portions, and wherein a number of the plurality of second images is greater than a number of the plurality of first images; process, by a perspective view encoder, the plurality of second images to generate a plurality of perspective view features; transform, by a view transformer, the plurality of perspective view features to bird's eye view (BEV) features; process, by a BEV encoder, the BEV features to generate encoded BEV features; and detect, based on the BEV features, one or more objects within the environment.

In some aspects, an apparatus for image processing is provided. The apparatus includes: means for receiving, from a plurality of image sensors, a plurality of first images of an environment; means for determining a plurality of portions from the plurality of first images to generate a plurality of second images, wherein each second image of the plurality of second images includes a respective portion of the plurality of portions, and wherein a number of the plurality of second images is greater than a number of the plurality of first images; means for processing the plurality of second images to generate a plurality of perspective view features; means for transforming the plurality of perspective view features to bird's eye view (BEV) features; means for processing the BEV features to generate encoded BEV features; and means for detecting, based on the BEV features, one or more objects within the environment.

In some aspects, one or more of the apparatuses described herein is, can be part of, or can include a vehicle (or a computing device, system, or component of a vehicle), a robotics device or system, an extended reality device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of a vehicle including multiple image sensors (e.g., cameras), in accordance with some aspects of the present disclosure.

FIG. 2 is a diagram illustrating an example system-on-a-chip (SOC), in accordance with some aspects of the disclosure.

FIG. 3 is a block diagram illustrating an example of a deep learning network, in accordance with some aspects of the disclosure.

FIG. 4 is a block diagram illustrating an example of a convolutional neural network, in accordance with some aspects of the disclosure.

FIG. 5 is a block diagram of an example transformer, in accordance with some aspects of the disclosure.

FIG. 6 is a diagram illustrating an example of a low-level perception (LLP) model, in accordance with some aspects of the disclosure.

FIG. 7 is a graph illustrating an example of a frustrum, in accordance with some aspects of the disclosure.

FIG. 8 is a diagram illustrating examples of a perspective view and a bird's eye view (BEV) of the frustrum of FIG. 7, in accordance with some aspects of the disclosure.

FIG. 9 is a diagram illustrating examples of a perspective view and a BEV of the frustrum of FIG. 7, where an image of the perspective view is split vertically and the frustrum of the BEV is correspondingly split vertically, in accordance with some aspects of the disclosure.

FIG. 10 is a diagram illustrating examples of an image and a corresponding attention map generated from the image, in accordance with some aspects of the disclosure.

FIG. 11 is a diagram illustrating examples of images split into one or more portions, in accordance with some aspects of the disclosure.

FIG. 12 is a flow diagram illustrating another example of a process for image processing, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, 2D visual perception has recently witnessed a rapid development. Multi-camera LLP models are often employed in computer vision to integrate data from multiple cameras (e.g., located in different locations). LLP models can be utilized to transform low-level information (e.g., from 2D images captured from multiple cameras) to higher-level information, such as extracted features (e.g., shapes) for object detection. Autonomous devices (e.g., such as autonomous driving vehicles and robotic devices) need to perceive their surroundings, which is a complex task in visual perception, for decision making purposes. These LLP models can be employed by autonomous devices to perform object detection (e.g., 3D or 2D object detection) within a bird's eye view (BEV) of their environment.

Running multi-camera centralized LLP models can be very computationally expensive. This computational expense may lead to having to compromise the model size and/or parameterization to minimize the compute requirements. As such, improved systems and techniques for multi-camera LLP models with a reduction in computational requirements can be beneficial.

In one or more aspects of the present disclosure, systems, apparatuses, methods (also referred to as processes), and computer-readable media (collectively referred to herein as “systems and techniques”) are described herein that provide solutions for low level perception (LLP) model distillation through perspective view cutting.

Various aspects relate generally to image processing. Some aspects more specifically relate to systems and techniques that provide solutions for multi-camera LLP models with reduced computational requirements. To implement this reduction, a subset of pixels from 2D input images can be selected to sum to a threshold value of a desired information power for each image frame, resulting in block patches or portions. The threshold value can be set based on normalized average attention maps for a view cutting training set. For each camera (e.g., image sensor) input, the blocks (or portions) are split into smaller patches with corresponding viewing frustrums, and divided up for input into the LLP model (e.g., n smaller patches times the number of camera inputs). In this way, the number of input pixels can be decreased, which can reduce the number of convolutions performed by the model.

In one or more aspects, during operation of a method for image processing, one or more processors can receive, from a plurality of image sensors (e.g., four image sensors), a plurality of first images (e.g., ten images captured from each of the four image sensors for a total of forty images) of an environment. The one or more processors can determine a plurality of portions (e.g., a selection of two portions from each of the forty images for a total of eighty portions) from the plurality of first images to generate a plurality of second images (e.g., the eighty portions make up a total of eighty images). In one or more examples, each second image of the plurality of second images can include a respective portion of the plurality of portions. In some examples, a number of the plurality of second images (e.g., eighty images) can be greater than a number of the plurality of first images (e.g., forty images). A perspective view encoder (e.g., an image-view encoder) can process the plurality of second images to generate a plurality of perspective view features. A view transformer can transform the perspective view features to bird's eye view (BEV) features. A BEV encoder can process the BEV features to generate encoded BEV features. A task-specific head (e.g., an object detector) can detect, based on the BEV features, one or more objects within the environment.

In one or more examples, the plurality of portions from the plurality of first images can be determined based on generating at least one average attention map for the plurality of first images (e.g., generating one average attention map from the ten images captured from each of the four image sensors, therefore, generating a total of four average attention maps). In some examples, generating the average attention map for the plurality of first images can be based on explainable artificial intelligence (XAI). In one or more examples, the plurality of portions from the plurality of first images can be determined further based on normalizing each of the average attention maps (e.g., the four average attention maps) to generate normalized average attention maps (e.g., generating a normalized average attention map from each of the four average attention maps, therefore, generating a total of four normalized average attention maps). In some examples, each of the average attention maps can be normalized such that a sum of attention values for all pixels of each of the average attention maps is equal to one. In one or more examples, the plurality of portions from the plurality of first images can be determined further based on determining pixels within the normalized average attention maps with attention values that sum to a threshold value. In some examples, one or more processors can determine the threshold value based on computational constraints.

In one or more examples, the plurality of portions from the plurality of first images can be determined based on generating at least one semantic segmentation map for the plurality of first images. In some examples, transforming, by the view transformer, the perspective view features to the BEV features can include determining corresponding locations within an associated image sensor frustrum for each second image of the plurality of second images. In one or more examples, a neural network of the view transformer can be trained based on the plurality of second images (e.g., the eighty images). In some examples, each image sensor of the plurality of image sensors can be located at a respective position. In one or more examples, the plurality of image sensors can be located on a vehicle or a robotic device.

Particular aspects of the subject matter described in this disclosure can be implemented to realize one or more of the following potential advantages. For example, the systems and techniques can provide a benefit of a reduction in the computational requirements for an LLP model, while still retaining the theoretical functionality of the LLP model.

Additional aspects of the present disclosure are described in more detail below.

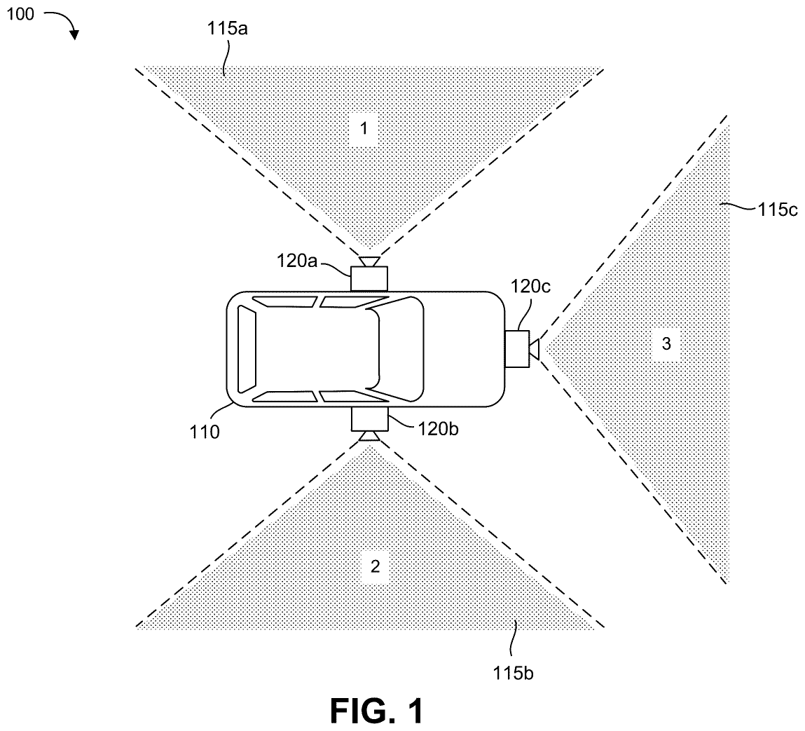

FIG. 1 shows an example of a device (e.g., an autonomous device) in the form of a vehicle that may be employed by the systems and techniques. In particular, FIG. 1 shows an example 100 of a vehicle 110 (e.g., an autonomous vehicle) including multiple image sensors 120a, 120b, 120c (e.g., cameras). In FIG. 1, the vehicle 110 is shown to have a plurality of image sensors 120a, 120b, 120c mounted at different locations on an exterior of the vehicle 110. For example, image sensor 120c is shown to be mounted on the front of the vehicle 110, and image sensors 120a, 120b are shown to be mounted on opposite sides of the vehicle 110. The image sensors 120a, 120b, 120c can capture images (e.g., 2D images) of an environment (e.g., including roads, traffic infrastructure, buildings, and pedestrians) of the vehicle 110.

FIG. 1 also shows views (e.g., view 1 115a, view 2 115b, and view 3 115c) of the image sensors 120a, 120b, 120c of the vehicle 110. FIG. 1 shows the views (e.g., view 1 115a, view 2 115b, and view 3 115c) of each of the image sensors 120a, 120b, 120c, respectively.

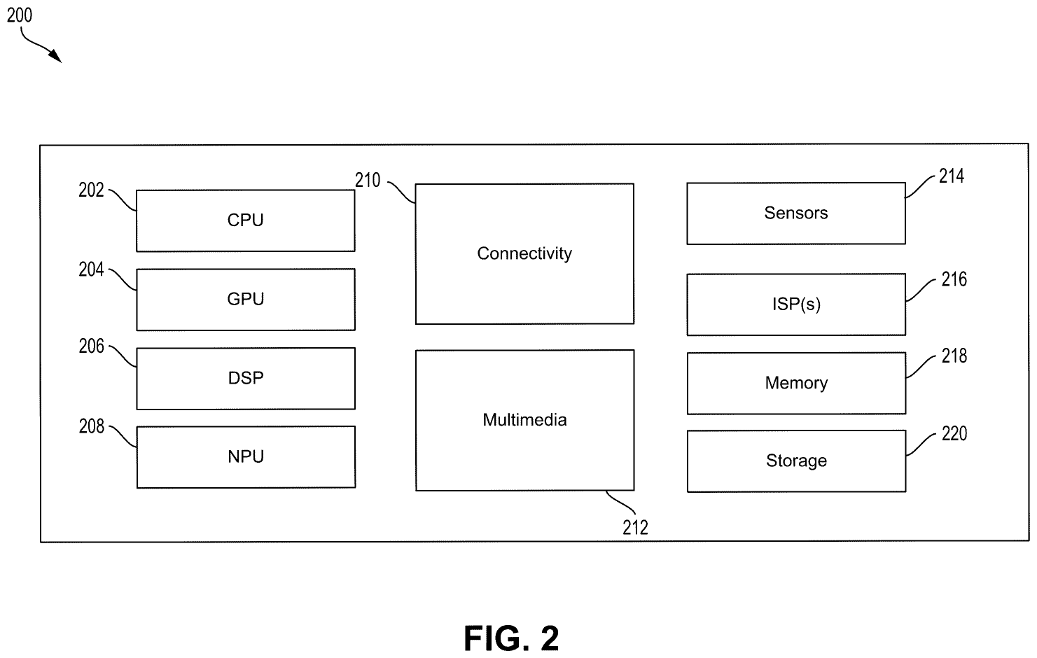

FIG. 2 illustrates an example implementation of a system-on-a-chip (SOC) 200, which may include a central processing unit (CPU) 202 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 208, in a memory block associated with a CPU 202, in a memory block associated with a graphics processing unit (GPU) 204, in a memory block associated with a digital signal processor (DSP) 206, in a memory block 218, and/or may be distributed across multiple blocks. Instructions executed at the CPU 202 may be loaded from a program memory associated with the CPU 202 or may be loaded from a memory block 218.

The SOC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, DSP 206, and/or GPU 204. The SOC 200 may also include one or more sensors 214, image signal processors (ISPs) 216, and/or storage 220. The one or more sensors 214 can include one or more image sensors (e.g., cameras), one or more radio detection and ranging (RADAR) sensors, one or more light detection and ranging (LADAR) sensors, any combination thereof, and/or other types of sensors.

The SOC 200 may be based on an ARM instruction set. In an aspect of the present disclosure, the instructions loaded into the CPU 202 may comprise code to search for a stored multiplication result in a lookup table (LUT) corresponding to a multiplication product of an input value and a filter weight. The instructions loaded into the CPU 202 may also comprise code to disable a multiplier during a multiplication operation of the multiplication product when a lookup table hit of the multiplication product is detected. In addition, the instructions loaded into the CPU 202 may comprise code to store a computed multiplication product of the input value and the filter weight when a lookup table miss of the multiplication product is detected.

SOC 200 and/or components thereof may be configured to perform image processing using machine learning techniques according to aspects of the present disclosure discussed herein. For example, SOC 200 and/or components thereof may be configured to perform disparity estimation refinement for pairs of images (e.g., stereo image pairs, each including a left image and a right image). SOC 200 can be part of a computing device or multiple computing devices. In some examples, SOC 200 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a robotic device, a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 202, the GPU 204, the DSP 206, the NPU 208, the connectivity block 210, the multimedia processor 212, the one or more sensors 214, the ISPs 216, the memory block 218 and/or the storage 220 can be part of the same computing device. For example, in some cases, the CPU 202, the GPU 204, the DSP 206, the NPU 208, the connectivity block 210, the multimedia processor 212, the one or more sensors 214, the ISPs 216, the memory block 218 and/or the storage 220 can be integrated into a smartphone, laptop, tablet computer, smart wearable device, video gaming system, server, and/or any other computing device. In other implementations, the CPU 202, the GPU 204, the DSP 206, the NPU 208, the connectivity block 210, the multimedia processor 212, the one or more sensors 214, the ISPs 216, the memory block 218 and/or the storage 220 can be part of two or more separate computing devices.

In one or more aspects, machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

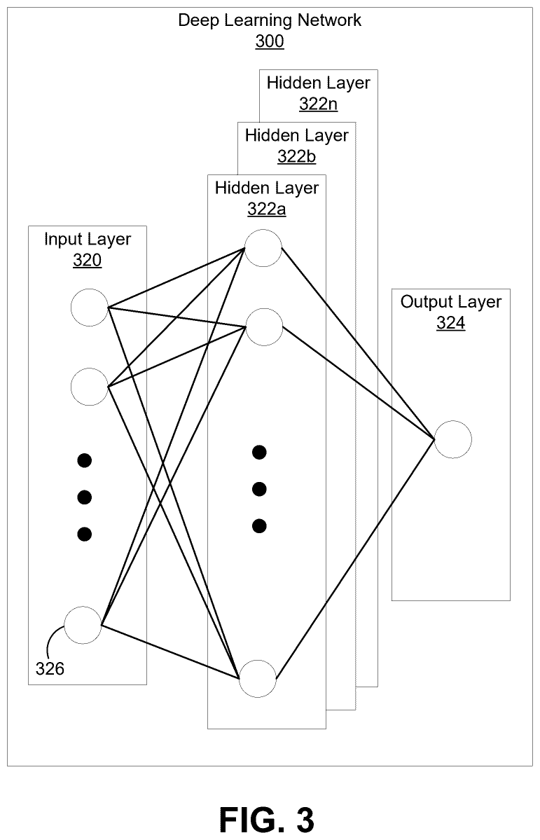

FIG. 3 is an illustrative example of a deep learning neural network 300 that can be used by a machine learning model. An input layer 320 includes input data. In some examples, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some examples, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 300 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

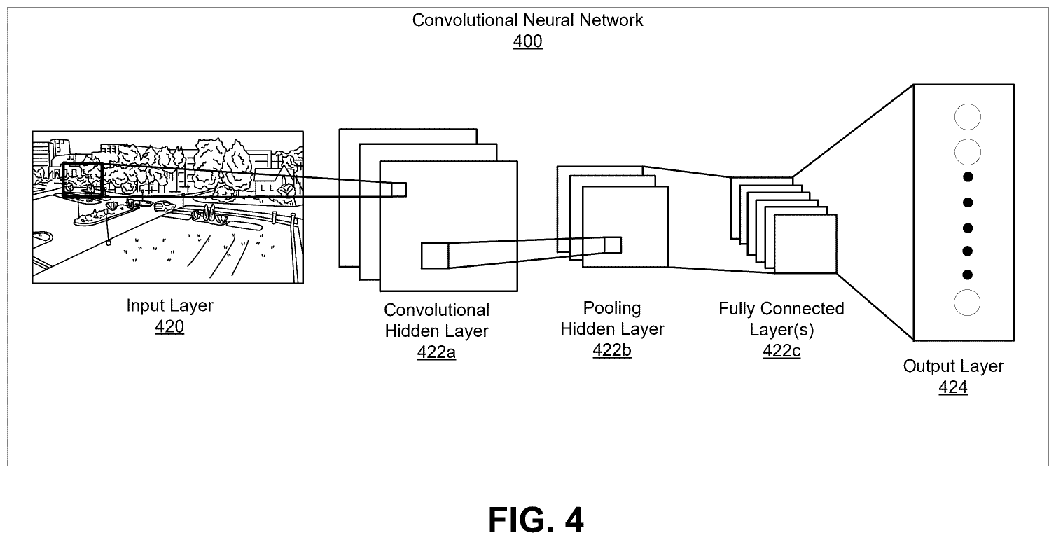

The neural network 300 can include any suitable deep network. As described previously, an example of a neural network 300 includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

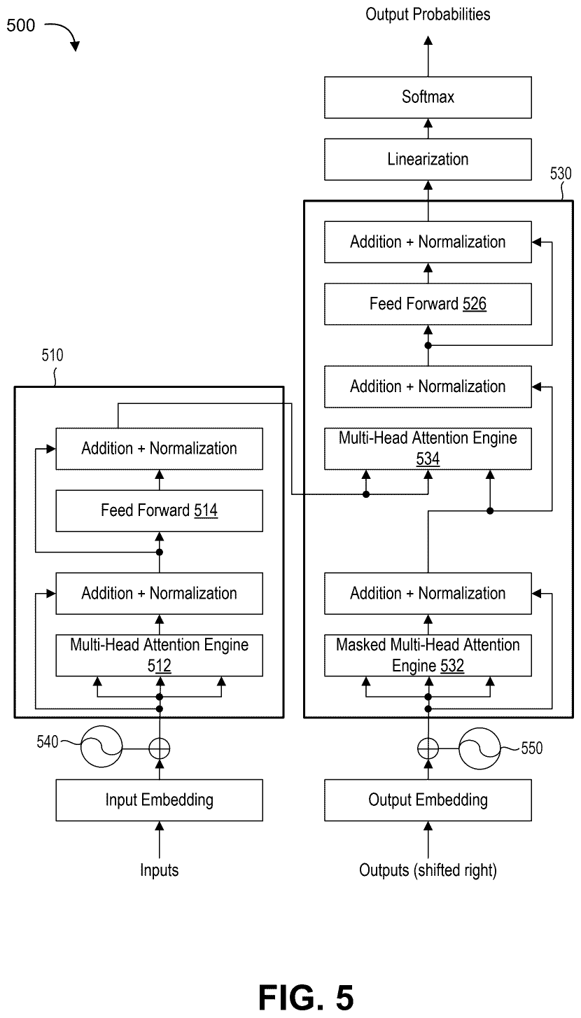

FIG. 5 is a block diagram of an example transformer. In a convolutional neural network (CNN) model, the number of operations required to relate signals from two arbitrary input or output positions grows in the distance between positions, which makes learning dependencies at different distant positions challenging for a CNN model. A transformer 500 reduces the operations of learning dependencies by using an encoder 510 and a decoder 530 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 510 is composed of a stack of six identical layers and each layer has two sub-layers. The first sub-layer is a multi-head self-attention engine 512, and the second sub-layer is a fully connected feed-forward network 514. A residual connection (not shown) connects around each of the sub-layers followed by normalization.

In the example transformer 500, the decoder 530 is also composed of a stack of six (6) identical layers. The decoder also includes a masked multi-head self-attention engine 532, a multi-head attention engine 534 over the output of the encoder 510, and a fully connected feed-forward network 526. Each layer includes a residual connection (not shown) around the layer, which is followed by layer normalization. The masked multi-head self-attention engine 532 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 540 to encode positions because the model does not contain recurrence and convolution and relative or absolute position of the tokens is needed. In the transformer 500, the positional encodings are added to the input embeddings at the bottom layer of the encoder 510 and the decoder 530. The positional encodings are summed with the embeddings because the positional encodings and embeddings have the same dimensions. A corresponding position decoder 550 is configured to decode the positions of the embeddings for the decoder 530.

In some aspects, the transformer 500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 500 can process input sequences of variable length, making the transformer 500 well-suited for natural language processing tasks where input lengths can vary greatly. Additionally, the self-attention mechanism allows the transformer 500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

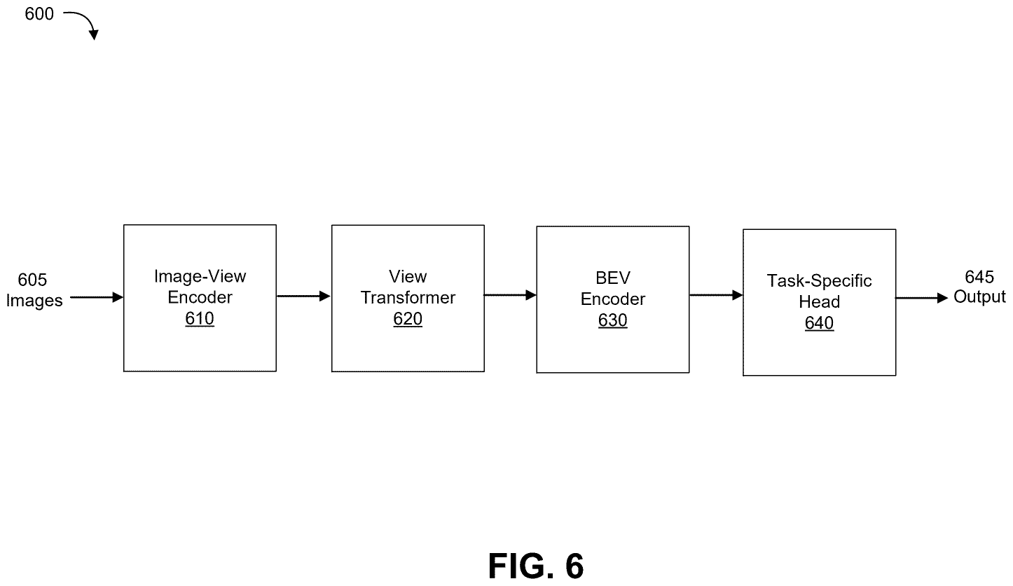

FIG. 6 shows an example of an LLP model that may be employed by the systems and techniques. In particular, FIG. 6 is a diagram illustrating an example of an LLP model 600, such as BEVDet. In FIG. 6, the LLP model 600 is shown to include a modular design including four modules, including a perspective view (e.g., image-view) encoder 610, a view transformer 620, a BEV encoder 630, and a task-specific head 640. In one or more examples, the LLP model 600 may include more or less number of modules than the number of modules shown in FIG. 6 and/or at least some different modules than the modules shown in FIG. 6. In one or more examples, the LLP model 600 may be employed by a device (e.g., an autonomous device), such as a vehicle (e.g., an autonomous vehicle, such as vehicle 110 of FIG. 1) or a robotic device.

During operation of the LLP model 600, one or more processors of the LLP model can receive, from a plurality of image sensors, a plurality of images 605 of an environment of the device (e.g., an autonomous device). The plurality of images may be captured by the plurality of image sensors (e.g., image sensors 120a, 120b, 120c of FIG. 1) that may be located at different locations on the device. As such, the plurality of images 605 can include a group of images captured from each of the image sensors. The plurality of images 605 can be input into the perspective view encoder 610 of the LLP model 600.

The perspective view encoder 610 can process (e.g., encode) the input images 605 into high-level features by extracting a plurality of perspective view features from the plurality of images 605. To exploit the power of multi-resolution features, the perspective view encoder 610 can include a backbone for high-level feature extraction and a neck for multi-resolution feature fusion. The perspective view encoder 610 can then output the perspective view features, which can be input into the view transformer 620.

The view transformer 620 can transform the perspective view features to BEV features. For example, the view transformer 620 can take the perspective view features as input, and can densely predict the depths through a classification manner to produce classification scores. The classification scores and the perspective view features can then be used in rendering a predefined point cloud of a frustrum. The BEV features can then be generated by applying a pooling operation along the vertical direction (e.g., a Z coordinate axis) of the point cloud. The view transformer 620 can then output the BEV features, which can be input into the BEV encoder 630.

The BEV encoder 630 can process (e.g., encode) the BEV features to generate encoded BEV features. Similar to the perspective view encoder 610, the BEV encoder 630 can include a backbone and a neck. The BEV encoder 630 can perceive some pivotal cues with high precision, such as scale, orientation, and velocity, as they are defined in the BEV space. The BEV encoder 630 can then output the encoded BEV features, which can be input into the task-specific head 640.

The task-specific head 640 can determine (e.g., detect), based on the encoded BEV features, one or more objects within the environment of the device (e.g., the autonomous device). The task-specific head 640 can be constructed upon the encoded BEV features. The task-specific head 640 can use the encoded BEV features to predict target values of objects or other semantic entities (e.g., 3D objects such pedestrians, vehicles, buildings, curbs, barriers, etc., 2D objects such as lines or maps, etc.) located within the environment. The object detection can be used to detect the position, scale, orientation, and/or speed of movable objects, such as pedestrians, vehicles, barriers, and so on, and/or other semantic entities (e.g., lines, maps, etc.). The task-specific head 640 can then produce an output 645, which can include the determined (e.g., detected) objects or other entities within the environment.

With LLP models, such as BEVDet, an arbitrary number (e.g., four) of sensors (e.g., image sensors such as cameras, RADAR sensors, LIDAR sensors, and/or other types of sensors) can be fused in the view transform step (e.g., performed by the view transformer 620). This fusing can be achieved by associating a frustum of points projected out into the world using camera calibration with each input (e.g., each input image, such as one or more images from the images 605)).

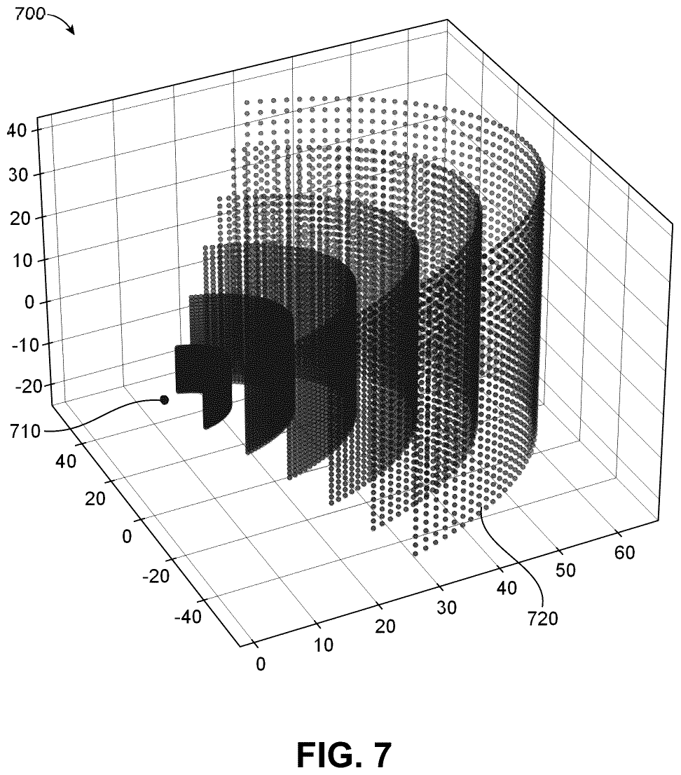

FIG. 7 shows an example of a frustrum of points. In particular, FIG. 7 is a 3D graph 700 illustrating an example of a frustrum. In the graph 700, the frustrum is shown to include a point cloud including of a plurality of points 720. The point cloud can be created based on image information associated with an image captured by an image sensor. As such, the frustrum is matched to the image. In one or more examples, the point cloud can be generated by projecting the image information out into the world based on the camera parameters. The graph 700 also shows the location 710 of the image sensor (e.g., camera) itself.

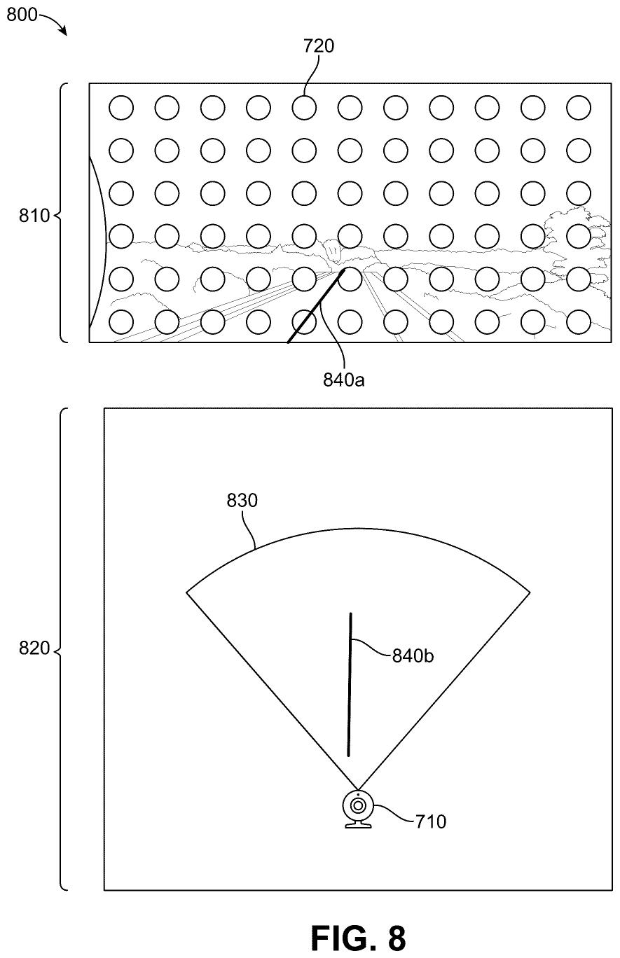

FIG. 8 is a diagram illustrating examples 800 of a perspective view 810 and a BEV 820 of the frustrum of FIG. 7. In FIG. 8, the perspective view 810 shows the points 720 of the frustrum overlaid upon the image used to create the frustrum. The image is shown to include a road. The middle of the road is denoted by line 840a.

The points 720 in the perspective view 810 correspond to the frustrum 830 (e.g., a view frustrum) shown in the BEV 820. The frustrum 830 is the field of view of the image sensor 710 (e.g., which may be within a perspective virtual camera system), which is also shown in the BEV 820. Line 840b, shown in the BEV 820, corresponds to the middle of the road of the image.

As previously mentioned, running multi-camera centralized LLP models can be very computationally expensive. This computational expense can result in having to compromise the model size and/or parameterization to minimize the compute requirements. In one or more aspects, the systems and techniques provide solutions for LLP model distillation through perspective view cutting that can allow for a reduction in the computational requirements.

In one or more aspects, an example of perspective view cutting is as follows. In one or more examples, during the view transform step (e.g., performed by the view transformer 620 of FIG. 6), multiple different image sensors (e.g., four image sensors, such as image sensors 120a, 120b, 120c of FIG. 1) can be fused together. For example, each image of a plurality of first images (e.g., where each image of four images is obtained by one of the four image sensors) may be split (e.g., by performing perspective view cutting) vertically to generate a second plurality of images (e.g., eight images). The corresponding frustrums to these images (e.g., the four images) also need to be split accordingly. For example, the frustrum shown in FIG. 7, which corresponds to one image, needs to be split vertically. The split of an image and the split of a corresponding frustrum need to be matched up with one another accordingly.

The second plurality of images (e.g., the eight images) can be then input into an LLP, such as LLP model 600 of FIG. 6 (e.g., as if the second plurality of images were captured from eight image sensors, instead of from only the four image sensors). The different inputs (e.g., the four images input or the eight images input) to the LLP model (e.g., LLP model 600 of FIG. 6) can use the same convolutional filters for weight sharing, and can then be fused during the view transform step (e.g., performed by the view transformer 620 of FIG. 6).

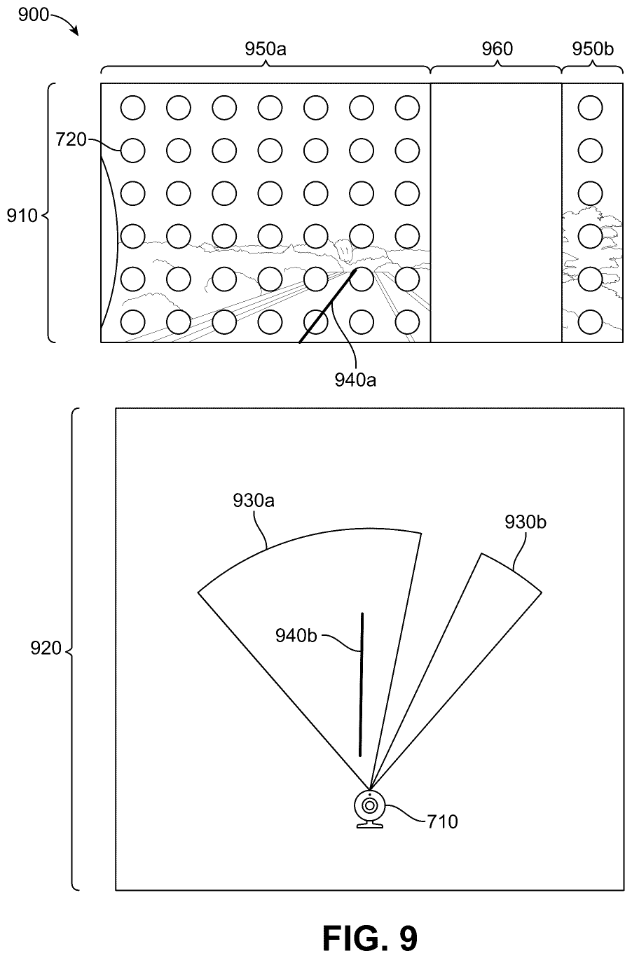

FIG. 9 is a diagram illustrating examples 900 of a perspective view 910 and a BEV 920 of the frustrum of FIG. 7, where an image of the perspective view 910 is split vertically and the frustrum of the BEV 920 is correspondingly split vertically. In FIG. 9, the perspective view 910 shows the points 720 of the frustrum overlaid upon the image used to create the frustrum. The image is shown to include a road, where the middle of the road is denoted by line 940a.

The image of the perspective view 910 is shown to be split vertically to form two portions 950a, 950b. Another portion 960 of the image is not used, thereby eliminating some of the pixels of the image. Each of the two portions 950a, 950b may be treated by an LLP model as a separate image.

Since the image has been split into portions 950a, 950b, the corresponding frustrum needs to be adjusted such that the image information in the portions 950a, 95b is projected onto the correct locations of the frustrum. As such, in the BEV 920, the frustrum is shown to be split corresponding to the split in the image, such that the frustrum includes two parts 930a, 930b. The points 720 in the portions 950a, 950b in the perspective view 910 correspond to the parts 930a, 930b of the frustrum of the BEV 920. The BEV 920 also shows the image sensor 710 and line 940b, which corresponds to the middle of the road of the image (e.g., shown in the portion 950a of the image).

The two portions 950a, 950b of the image can then be treated as two separate images (e.g., as if the two separate images were captured from two image sensors, instead of from only one image sensor). The portions 950a, 950b (instead of the image itself) can be input into an LLP model (e.g., the LLP model 600 of FIG. 6). Since the portions 950a, 950b contain a lower number of pixels than the image itself, the LLP model will have a reduced computational requirement for the processing.

In one or more aspects, another example of perspective view cutting that can allow for a reduction in the computational requirements in an LLP model is as follows. In one or more examples, the perspective view cutting can allow for a reduction in the computation required to run an inference with a network (e.g., a neural network within a view transformer of an LLP model).

In one or more examples, during operation of a process for a perspective view cutting, one or more processors can receive, from a plurality of image sensors (e.g., four image sensors) of a device, a plurality of first images (e.g., ten images captured from each of the four image sensors for a total of forty images) of an environment of the device. In one or more examples, the plurality of image sensors may be located on the device (e.g., an autonomous device), such as a vehicle (e.g., an autonomous vehicle) or a robotic device. In some examples, each image sensor of the plurality of image sensors may be located at a respective position on the device. A computationally expensive LLP network (e.g., an LLP model, such as the LLP model 600 of FIG. 6) can be trained (e.g., based on the plurality of first images) for visual detection of one or more objects (e.g., within the environment) to convergence.

After the LLP network has been trained to convergence, one or more processors can determine a plurality of portions (e.g., a selection of two portions from each of the forty images for a total of eighty portions) of the first plurality of images (e.g., the forty images) to generate a plurality of second images (e.g., the eighty portions make up a total of eighty images). Each second image of the plurality of second images can include a respective portion of the plurality of portions. A number of the plurality of second images (e.g., eighty images) is greater than a number of the plurality of first images (e.g., forty images).

In one or more examples, the plurality of portions from the plurality of first images can be determined based on generating at least one average attention map for the plurality of first images (e.g., generating one average attention map from the ten images captured from each of the four image sensors, therefore, generating a total of four average attention maps). In some examples, generating the average attention map for the plurality of first images can be based on explainable artificial intelligence (XAI). For example, XAI may be run on the plurality of first images (e.g., a “view cutting calibration-dataset”) to produce the average attention maps. An average attention map can be created for the entire data set (e.g., ten images) for each image sensor, where there are N number of first images in the plurality of first images (e.g., N may be equal to forty).

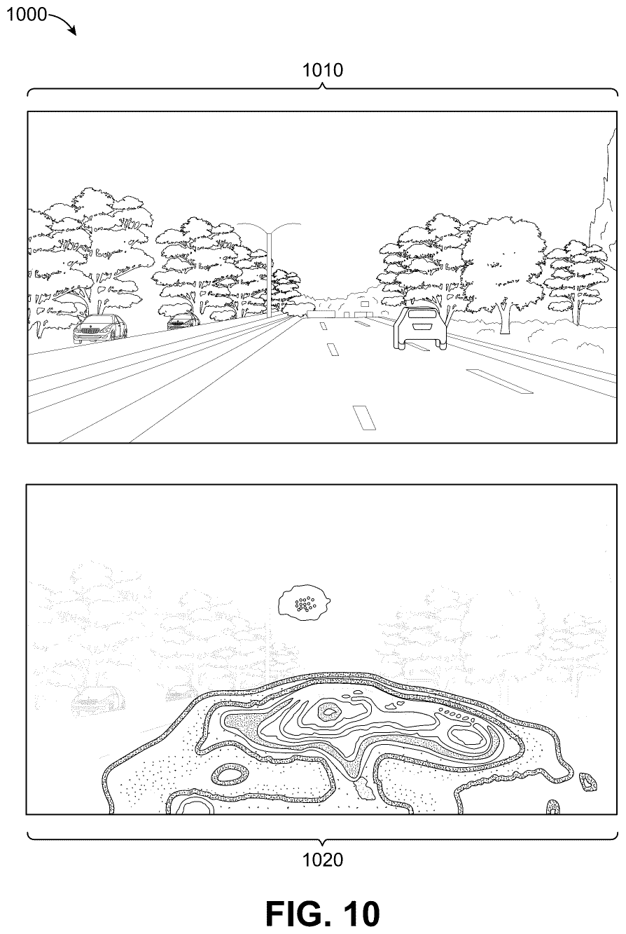

FIG. 10 is a diagram illustrating examples 1000 of an image 1010 and a corresponding attention map 1020 generated from the image 1010. In one or more examples, the image 1010 may be captured by an image sensor mounted onto a vehicle (e.g., an autonomous vehicle). The image 1010 is shown to include a road. In some examples, the attention map 1020 may be generated, based on the image 1010, by using some XAI technique that can assign high attention values to pixels in the image 1010 that are relevant to object detection related to the road of the image 1010.

After the average attention maps (e.g., four average attention maps) are generated, each of the average attention maps can be normalized to generate normalized average attention maps (e.g., generating a normalized average attention map from each of the four average attention maps, therefore, generating a total of four normalized average attention maps). In one or more examples, each of the average attention maps can be normalized such that a sum of attention values for all pixels of each of the average attention maps is equal to one (1).

A threshold value (T) may be determined (e.g., by one or more processors) based on computational constraints of the LLP model (e.g., the LLP model 600 of FIG. 6). The threshold value T may be selected such that T is between zero and one (e.g., 0<T<1) of the total desired “information power” in the images.

After the threshold value T has been determined, one or more processors can solve the optimization problem of determining pixels within the normalized average attention maps (e.g., the four normalized average attention maps) with attention values that sum to the threshold value T. The determination of these pixels can be done under one or more constraints such that the selected pixels can form block patches or portions (e.g., the plurality of portions). As such, each input camera image C (e.g., each of the forty images of the plurality of first images) can be split into Ne smaller patches or portions (e.g., for a total of eighty portions). The corresponding frustrums to these portions can be divided (e.g., split) up accordingly and reassigned to the portions.

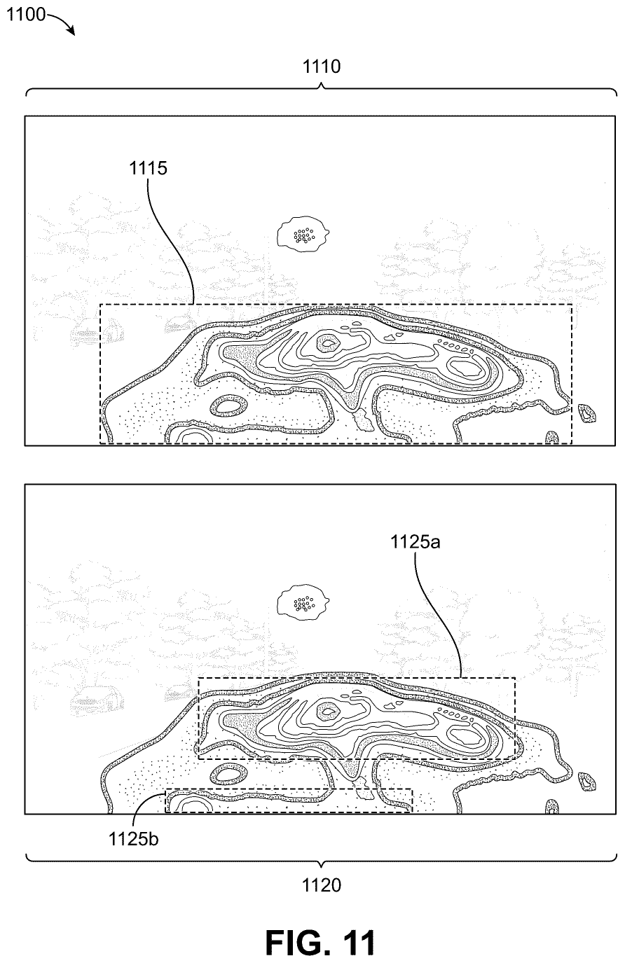

FIG. 11 is a diagram illustrating examples of images 1110, 1120 cut up (or split) into one or more portions 1115, 1125a, 1125b. In one or more examples, it can be assumed that the attention map 1020 of FIG. 10 is a final average attention map for a specific image sensor. In some examples, T1 and T2 can be determined to be two “information power” threshold values, where T1 is greater than T2 (e.g., T1>T2). The image 1110 can be cut up based on the threshold value T1 to generate the portion 1115. The image 1120 can be cut up based on the threshold value T2 to generate the portions 1125a, 1125b. By selecting different values for the threshold value T, the total amount of information power captured by the one or more portions can be balanced with the number of pixels that the LLP model will have to run convolutions on. In one or more examples, a single image may be cut up (or split) to generate more than one or two portions (e.g., three portions, four portions, etc.) as shown in the FIG. 11.

The LLP network (e.g., LLP model 600 of FIG. 6) is modified (e.g., in some cases without being retrained or in some cases being retrained via fine-tuning through additional training epochs), to accept N_{c}*C images (e.g., the eighty images of the plurality of second images are formed from the eighty portions) as input instead of N (e.g., the forty images). All (or in some cases less than all) of the weights for the N initial paths can be duplicated/shared for the N_{c}*C new inputs.

In one or more examples, it can be quite common to share weights (e.g., convolution kernels/filters) between the regular N number of images used in an LLP model up until the layers of the view transformer (e.g., the view transformer 620 of FIG. 6). As such, the network architecture of the LLP model will have N number of duplicates of the image view encoder (e.g., the perspective view encoder 610 of FIG. 6) of the network. On reasonable inference platforms, this duplication should not incur a significant extra memory overhead. When the portions are generated and the inputs change from N to N_{c}*C inputs, this duplication is simply performed that many times instead.

Since the corresponding frustums are also cut up (or split) accordingly, every input image portion will be associated and projected correctly during the view transformer stage. The trained depth distribution (which is also shared) should continue to operate well for most tasks. However, a potential issue may arise if the images are cut up too aggressively such that many of the pixels of images are discarded. In these cases, if the depth distributions transfer poorly for some task, the network (e.g., LLP model) can be fine-tuned for a few epochs based on the new inputs (e.g., the N_{c}*C inputs). As such, in one or more examples, a neural network of the view transformer can be trained based on the N_{c}*C images (e.g., the eighty images of the plurality of second images formed from the eighty portions).

In one or more examples, the total number of pixels for these new N_{c}*C images (e.g., the eighty images) will be strictly smaller than the total number of pixels in the initial N images (e.g., the forty images). Depending upon the chosen threshold value T and the view cutting calibration-dataset (e.g., the forty images), the ratio between the initial number of pixels and the final number of pixels will vary.

By decreasing the number of input pixels, the number of convolutions to be performed can be directly reduced and, as such, ultimately the network cost can be reduced. As such, the LLP model can be run with a reduced number of pixels from the initial N images, while maintaining a high “information power” (e.g., such as 0.95), due to the fact that many of the pixels (e.g., located in the sky of the images) in the initial N images are not vital to the network's task (e.g., detection of objects within a road).

In one or more examples, the plurality of portions from the plurality of first images can be determined based on other methods other than generating at least one average attention map. For example, the plurality of portions from the plurality of first images can be determined based on generating at least one semantic segmentation map for the plurality of first images. For another example, the plurality of portions from the plurality of first images can be determined based on generating at least one saliency map for the plurality of first images. For another example, the plurality of portions from the plurality of first images can be determined based on manually choosing the important pixels within the plurality of first images. For yet another example, the plurality of portions from the plurality of first images can be determined based on object detection performed on the plurality of first images.

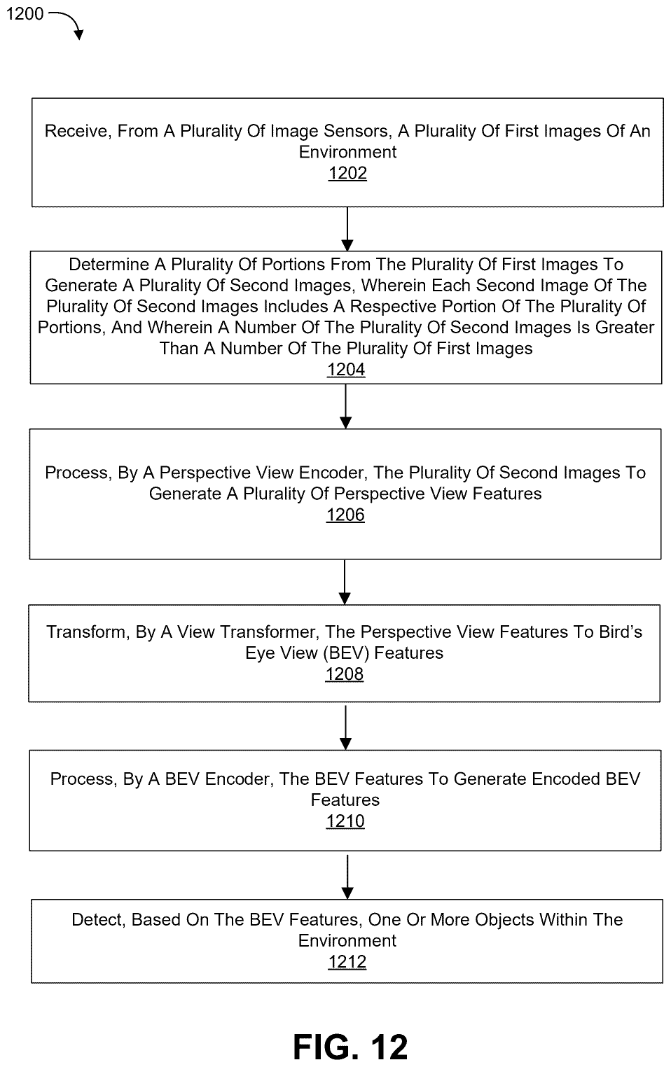

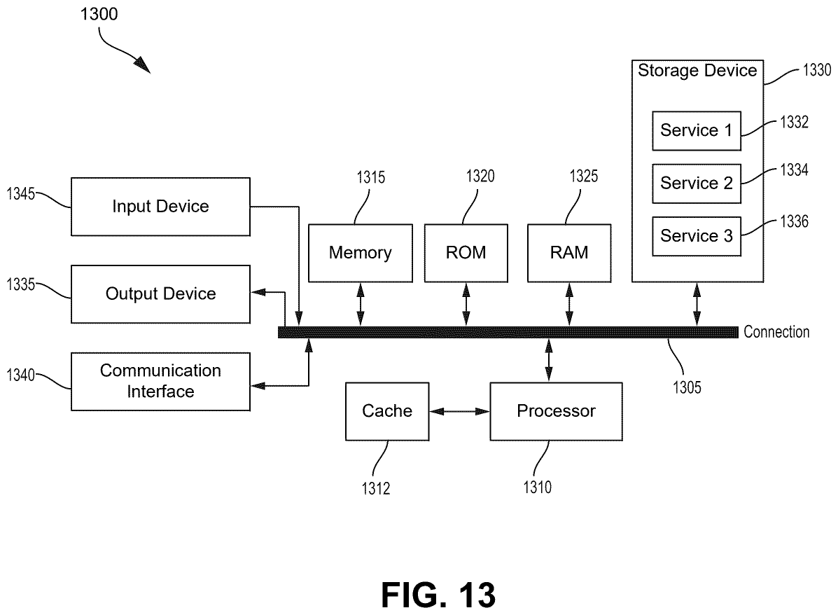

FIG. 12 is a flow chart illustrating an example of a process 1200 for image processing. The process 1200 can be performed by a computing device (e.g., a computing device or computing system 1300 of FIG. 13) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 1200 may be implemented as software components that are executed and run on one or more processors (e.g., processor 1310 of FIG. 13, or other processor(s)). Further, the transmission and reception of signals by the computing device in the process 1200 may be enabled, for example, by one or more antennas and/or one or more transceivers (e.g., wireless transceiver(s)).

At block 1202, the computing device (or component thereof) can receive, from a plurality of image sensors, a plurality of first images of an environment. In some aspects, each image sensor of the plurality of image sensors is located at a respective position. In some cases, the plurality of image sensors is located on a vehicle, a robotic device, or other type of vehicle or system.

At block 1204, the computing device (or component thereof) can determine a plurality of portions from the plurality of first images to generate a plurality of second images. A number of the plurality of second images is greater than a number of the plurality of first images. Each second image of the plurality of second images includes a respective portion of the plurality of portions. For instance, the computing device (or component thereof) can determine a number of portions (e.g., two portions, three portions, etc.) from each image of a total number of images (e.g., from a total of forty images, sixty images, etc.) to generate a plurality of second images (e.g., two portions can be selected from each image of a total of forty images, resulting in eighty portions that make up a total of eighty images).

The computing device (or component thereof) can determine the plurality of portions from the plurality of first images using various techniques. In some aspects, the computing device (or component thereof) can generate at least one average attention map for the plurality of first images. The computing device (or component thereof) can determine the plurality of portions from the plurality of first images based on the at least one average attention map. In some cases, the computing device (or component thereof) can generate the at least one average attention map for the plurality of first images based on explainable artificial intelligence (XAI). Additionally or alternatively, in some aspects, the computing device (or component thereof) can normalize the at least one average attention map to generate at least one normalized average attention map. The computing device (or component thereof) can determine the plurality of portions from the plurality of first images based on the at least one normalized average attention map. In some cases, the computing device (or component thereof) can normalize the at least one average attention map such that a sum of attention values for all pixels of the at least one average attention map is equal to one. Additionally or alternatively, in some aspects, the computing device (or component thereof) can determine pixels within the at least one normalized average attention map with attention values that sum to a threshold value. The computing device (or component thereof) can determine the plurality of portions from the plurality of first images further based on the determined pixels within the at least one normalized average attention map with attention values that sum to the threshold value. In some cases, the computing device (or component thereof) can determine the threshold value based on computational constraints. Additionally or alternatively, in some aspects, the computing device (or component thereof) can generate at least one semantic segmentation map for the plurality of first images. The computing device (or component thereof) can determine the plurality of portions from the plurality of first images based on the at least one semantic segmentation map.

At block 1206, the computing device (or component thereof) can process (e.g., by a perspective view encoder) the plurality of second images to generate a plurality of perspective view features.

At block 1208, the computing device (or component thereof) can transform (e.g., by a view transformer) the plurality of perspective view features to bird's eye view (BEV) features. In some aspects, to transform the plurality of perspective view features to the BEV features, the computing device (or component thereof) can determine corresponding locations within an associated image sensor frustrum for each second image of the plurality of second images. In some aspects, the computing device (or component thereof) can train, based on the plurality of second images, a neural network of the view transformer.

At block 1210, the computing device (or component thereof) can process (e.g., by a BEV encoder) the BEV features to generate encoded BEV features.

At block 1212, the computing device (or component thereof) can detect, based on the BEV features, one or more objects within the environment.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for LLP model distillation through perspective view cutting. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for image processing, the apparatus comprising: at least one memory; and at least one processor coupled to the at least one memory and configured to: receive, from a plurality of image sensors, a plurality of first images of an environment; determine a plurality of portions from the plurality of first images to generate a plurality of second images, wherein each second image of the plurality of second images comprises a respective portion of the plurality of portions, and wherein a number of the plurality of second images is greater than a number of the plurality of first images; process, by a perspective view encoder, the plurality of second images to generate a plurality of perspective view features; transform, by a view transformer, the plurality of perspective view features to bird's eye view (BEV) features; process, by a BEV encoder, the BEV features to generate encoded BEV features; and detect, based on the BEV features, one or more objects within the environment.
Aspect 2. The apparatus of Aspect 1, wherein the at least one processor is configured to: generate at least one average attention map for the plurality of first images; and determine the plurality of portions from the plurality of first images based on the at least one average attention map.
Aspect 3. The apparatus of Aspect 2, wherein the at least one processor is configured to generate the at least one average attention map for the plurality of first images based on explainable artificial intelligence (XAI).
Aspect 4. The apparatus of any of Aspects 2 or 3, wherein the at least one processor is configured to: normalize the at least one average attention map to generate at least one normalized average attention map; and determine the plurality of portions from the plurality of first images based on the at least one normalized average attention map.
Aspect 5. The apparatus of Aspect 4, wherein the at least one processor is configured to normalize the at least one average attention map such that a sum of attention values for all pixels of the at least one average attention map is equal to one.
Aspect 6. The apparatus of any of Aspects 4 or 5, wherein the at least one processor is configured to: determine pixels within the at least one normalized average attention map with attention values that sum to a threshold value; and determine the plurality of portions from the plurality of first images further based on the determined pixels within the at least one normalized average attention map with attention values that sum to the threshold value.
Aspect 7. The apparatus of Aspect 6, wherein the at least one processor is configured to determine the threshold value based on computational constraints.
Aspect 8. The apparatus of any of Aspects 1 to 7, wherein the at least one processor is configured to: generate at least one semantic segmentation map for the plurality of first images; and determine the plurality of portions from the plurality of first images based on the at least one semantic segmentation map.
Aspect 9. The apparatus of any of Aspects 1 to 8, wherein, to transform the plurality of perspective view features to the BEV features, the at least one processor is configured to determine corresponding locations within an associated image sensor frustrum for each second image of the plurality of second images.
Aspect 10. The apparatus of any of Aspects 1 to, wherein the at least one processor is configured to: train, based on the plurality of second images, a neural network of a view transformer; and process the plurality of second images using the view transformer to generate the plurality of perspective view features.
Aspect 11. The apparatus of any of Aspects 1 to 10, wherein each image sensor of the plurality of image sensors is located at a respective position.
Aspect 12. The apparatus of any of Aspects 1 to 11, wherein the plurality of image sensors is located on a vehicle or a robotic device.
Aspect 13. A method for image processing, the method comprising: receiving, from a plurality of image sensors, a plurality of first images of an environment; determining a plurality of portions from the plurality of first images to generate a plurality of second images, wherein each second image of the plurality of second images comprises a respective portion of the plurality of portions, and wherein a number of the plurality of second images is greater than a number of the plurality of first images; processing, by a perspective view encoder, the plurality of second images to generate a plurality of perspective view features; transforming, by a view transformer, the plurality of perspective view features to bird's eye view (BEV) features; processing, by a BEV encoder, the BEV features to generate encoded BEV features; and detecting, based on the BEV features, one or more objects within the environment.
Aspect 14. The method of Aspect 13, wherein the plurality of portions from the plurality of first images are determined based on generating at least one average attention map for the plurality of first images.
Aspect 15. The method of Aspect 14, wherein generating the at least one average attention map for the plurality of first images is based on explainable artificial intelligence (XAI).
Aspect 16. The method of any of Aspects 14 or 15, wherein the plurality of portions from the plurality of first images are determined further based on normalizing the at least one average attention map to generate at least one normalized average attention map.
Aspect 17. The method of Aspect 16, wherein the at least one average attention map is normalized such that a sum of attention values for all pixels of the at least one average attention map is equal to one.
Aspect 18. The method of any of Aspects 16 or 17, wherein the plurality of portions from the plurality of first images are determined further based on determining pixels within the at least one normalized average attention map with attention values that sum to a threshold value.
Aspect 19. The method of Aspect 18, further comprising determining the threshold value based on computational constraints.
Aspect 20. The method of any of Aspects 13 to 19, wherein the plurality of portions from the plurality of first images are determined based on generating at least one semantic segmentation map for the plurality of first images.
Aspect 21. The method of any of Aspects 13 to 20, wherein transforming, by the view transformer, the plurality of perspective view features to the BEV features comprises determining corresponding locations within an associated image sensor frustrum for each second image of the plurality of second images.
Aspect 22. The method of any of Aspects 13 to 21, further comprising training, based on the plurality of second images, a neural network of the view transformer.
Aspect 23. The method of any of Aspects 13 to 22, wherein each image sensor of the plurality of image sensors is located at a respective position.
Aspect 24. The method of any of Aspects 13 to 23, wherein the plurality of image sensors is located on a vehicle or a robotic device.
Aspect 25. A non-transitory computer-readable medium having stored thereon instructions that, when executed by at least one processor, cause the at least one processor to perform operations according to any of Aspects 13 to 24.
Aspect 26. An apparatus for image processing, the apparatus including one or more means for performing operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
receive, from a plurality of image sensors, a plurality of first images of an environment;
determine a plurality of portions from the plurality of first images to generate a plurality of second images, wherein each second image of the plurality of second images comprises a respective portion of the plurality of portions, and wherein a number of the plurality of second images is greater than a number of the plurality of first images;
process the plurality of second images to generate a plurality of perspective view features;
transform the plurality of perspective view features to bird's eye view (BEV) features;
process the BEV features to generate encoded BEV features; and
detect, based on the BEV features, one or more objects within the environment.

2. The apparatus of claim 1, wherein the at least one processor is configured to:
generate at least one average attention map for the plurality of first images; and
determine the plurality of portions from the plurality of first images based on the at least one average attention map.

3. The apparatus of claim 2, wherein the at least one processor is configured to generate the at least one average attention map for the plurality of first images based on explainable artificial intelligence (XAI).

4. The apparatus of claim 2, wherein the at least one processor is configured to:
normalize the at least one average attention map to generate at least one normalized average attention map; and
determine the plurality of portions from the plurality of first images based on the at least one normalized average attention map.

5. The apparatus of claim 4, wherein the at least one processor is configured to normalize the at least one average attention map such that a sum of attention values for all pixels of the at least one average attention map is equal to one.

6. The apparatus of claim 4, wherein the at least one processor is configured to:
determine pixels within the at least one normalized average attention map with attention values that sum to a threshold value; and
determine the plurality of portions from the plurality of first images further based on the determined pixels within the at least one normalized average attention map with attention values that sum to the threshold value.

7. The apparatus of claim 6, wherein the at least one processor is configured to determine the threshold value based on computational constraints.

8. The apparatus of claim 1, wherein the at least one processor is configured to:
generate at least one semantic segmentation map for the plurality of first images; and
determine the plurality of portions from the plurality of first images based on the at least one semantic segmentation map.

9. The apparatus of claim 1, wherein, to transform the plurality of perspective view features to the BEV features, the at least one processor is configured to determine corresponding locations within an associated image sensor frustrum for each second image of the plurality of second images.

10. The apparatus of claim 1, wherein the at least one processor is configured to:
train, based on the plurality of second images, a neural network of a view transformer; and
process the plurality of second images using the view transformer to generate the plurality of perspective view features.

11. The apparatus of claim 1, wherein each image sensor of the plurality of image sensors is located at a respective position.

12. The apparatus of claim 1, wherein the plurality of image sensors is located on a vehicle or a robotic device.

13. A method for image processing, the method comprising:
receiving, from a plurality of image sensors, a plurality of first images of an environment;
determining a plurality of portions from the plurality of first images to generate a plurality of second images, wherein each second image of the plurality of second images comprises a respective portion of the plurality of portions, and wherein a number of the plurality of second images is greater than a number of the plurality of first images;
processing, by a perspective view encoder, the plurality of second images to generate a plurality of perspective view features;
transforming, by a view transformer, the plurality of perspective view features to bird's eye view (BEV) features;
processing, by a BEV encoder, the BEV features to generate encoded BEV features; and
detecting, based on the BEV features, one or more objects within the environment.

14. The method of claim 13, wherein the plurality of portions from the plurality of first images are determined based on generating at least one average attention map for the plurality of first images.

15. The method of claim 14, wherein generating the at least one average attention map for the plurality of first images is based on explainable artificial intelligence (XAI).

16. The method of claim 14, wherein the plurality of portions from the plurality of first images are determined further based on normalizing the at least one average attention map to generate at least one normalized average attention map.

17. The method of claim 16, wherein the at least one average attention map is normalized such that a sum of attention values for all pixels of the at least one average attention map is equal to one.

18. The method of claim 16, wherein the plurality of portions from the plurality of first images are determined further based on determining pixels within the at least one normalized average attention map with attention values that sum to a threshold value.

19. The method of claim 13, wherein the plurality of portions from the plurality of first images are determined based on generating at least one semantic segmentation map for the plurality of first images.

20. The method of claim 13, wherein transforming, by the view transformer, the plurality of perspective view features to the BEV features comprises determining corresponding locations within an associated image sensor frustrum for each second image of the plurality of second images.
